(19) United States
(12) Patent Application Publication
(10) Pub. No.: US 2003/0202558 A1
(43) Pub. Date: Oct. 30, 2003

(54) Wireless electronic cooking thermometer

(76) Inventors: Charles Wong Tak Chung, Quarry Bay (HK); Michelle Cheng Kin Cheung, Tusen Wan (HK); Ken Sin Ka Hong, Clearwater Bay (HK); Keith Kibiloski, Virginia Beach, VA (US); So Si Kin, North Point (HK)

Correspondence Address: James S. Pristelski, Suite 2850, 200 W. Adams Street, Chicago, IL, 60606, US

(21) Appl. No.: 10/135,740

(22) Filed: Apr. 30, 2002

(51) Int. Cl. G01K 1/02

(52) U.S. Cl. 374/155; 374/141; 374/149

(57) ABSTRACT

A wireless cooking thermometer consisting of a transmitter unit and a receiver unit. The transmitter unit senses the cooking temperature of food item and periodically transmits the temperature as an RF signal to the receiver unit. The receiver unit compares the current food temperature to preprogrammed values representative of different levels of doneness and provides visual and audible alerts when the food temperature reaches one level of doneness below the selected level, when the food reaches the selected level of doneness, and again when the food reaches an overcooked level. A display on the receiver unit has an ascending bar graph to visually depict the progress of cooking through the various cooking levels. The display also has indicia to display the type of meat selected, the current temperature of the sensing probe, the temperature corresponding to the selected level of doneness and an overcook indicator. When the food is cooked to an overcooked condition, the type of meat indicia becomes a timer to indicate the amount of time that the meat has overcooked. The display has backlighting of one color during cooking to the selected level and another color when cooking past the selected level. A clasp is separately insertable into different apertures of the receiver housing to operate as a belt clip to attach the receiver to a person, as a hangar to suspend the receiver in a desired location or as a base to stand the receiver on a horizontal surface.

### BACKGROUND OF THE INVENTION

This invention relates generally to apparatus for monitoring the cooking progress of a food item, such as meat, throughout the cooking process. The wireless cooking thermometer has two portions. A transmitter unit resides near the food item being cooked. A receiver unit is portable and is normally carried by the user. The receiver unit has a display with a plurality of indicia for indicating the current status of the cooking process. The wireless cooking thermometer provides visual and/or audible alerts preferably when the food item reaches the doneness level immediately below the selected doneness level, when the food item reaches the selected doneness level and when the food item begins to be overcooked. The display can be backlit with a first color while the food item is cooking toward the selected level of doneness. The backlighting changes to a different color as the food item begins to be overcooked. An elapsed timer gives the amount of time that overcooking has occurred. The receiver unit can have a clasp that may alternately be used to clip to the user's clothing, to hang or suspend the receiver unit, or to form a base to stand the receiver unit on a horizontal surface. The invention also includes related processes.

Some food items are typically prepared according to individual preferences. For example, meat that is in the form of steaks, roasts, chops, racks, patties, and the like, may be cooked rare, medium rare, medium, medium well, or well done. These different cooking choices are often referred to as “doneness” or “taste”. Beef is one meat that is particularly well suited to different levels of doneness. On the other hand, many individuals prefer to have certain kinds of meat cooked until well done. Such well done meats typically include poultry and pork.

Various forms of meat thermometers are known that provide an indication of the level of doneness. Typically, a temperature sensing tip is inserted into the meat to measure the internal temperature. It is known that certain temperature ranges correspond to different levels of doneness for various kinds of meat. One of the problems that users of meat thermometers face is that most of the inexpensive cooking thermometers only display an approximate temperature. The user must translate the temperature to a level of doneness for that specific type of meat. Such thermometers also do not provide for any displays and alerts as the meat begins to approach the selected level of doneness, or as it begins to pass the selected level of doneness resulting in overcooking. Of course, a cook is usually preparing more than meat. Salad, potatoes, rice or pasta, a vegetable and, perhaps, a desert are frequently prepared at the same time that the meat is cooking. This means that the user of the thermometer can only occasionally check the thermometer to monitor the progress of the meat. As a result, the meat can easily be cooked past the desired level of doneness, i.e., overcooked.

More sophisticated cooking thermometers include the electronic chef's fork described in U.S. Pat. No. 6,065,391, issued on May 23, 2000. This device has greatly improved features including selectable meat types, and a readout for the current level of doneness. However, this chef's fork does not provide any type of alert when the meat is at the level below the selected level of doneness, nor does it provide any alert that the meat is passing the desired level of doneness into an overcooked condition. The user must occasionally check this device to monitor the progress of the cooking to avoid overcooked meat.

Moreover, many electronic thermometers cannot withstand the temperatures inside ovens or barbeque grills while the meat is cooking or broiling. This is due to the temperature limitations of displays, thermoplastic housings, internal electronics, conventional batteries, and the like. Thus, many electronic thermometers cannot be left inside an oven or grille during the entire cooking process. Instead, the user must periodically and temporarily insert the electronic thermometer into the meat, obtain a current temperature reading and then remove the thermometer prior to further cooking. This increases the risk that the meat will be cooked past the desired taste due to the time demands and distractions inherent in preparing the other portions of the meal.

### SUMMARY OF THE INVENTION

The present invention has several aspects and features. This wireless cooking thermometer has two portions; a transmitter unit and a receiver unit. The transmitter unit has a temperature probe for insertion into the food item. The transmitter unit continuously takes measurements of the internal food temperature and transmits the temperature information via a radio frequency (RF) signal to a receiver unit. The receiver unit has a housing with a display, internal circuitry, including memory, and user selectable inputs. A wide range of different types of meats, including ground meats, is selectable by the user. The user also enters a selected doneness level for the selected meat via the user selectable inputs.

The display on the receiver unit has a plurality of indicia for indicating the current cooking status including various doneness levels for the selected food item. An indication is given upon the food item reaching the level of doneness immediately below the selected doneness so that the cooking person can be prepared to stop the cooking process as soon as the food item reaches the selected level of doneness. The display has bar graphs with separate segments for each of the doneness levels to indicate the progress of the cooking process. The display is preferably backlit with a first color, such as green, before the food item reaches the selected doneness level, and with a second color, such as red, after the food item reaches the selected doneness level. An overcook timer is included in the display to show the amount of time that the food item has been cooking past the selected doneness level. The display also has an out-of-range alert to indicate when the receiver unit is not receiving the RF signal from the transmitter unit.

The receiver unit is adapted to be carried by a person so that the cooking process can be continuously monitored, including in those instances when other parts of the meal are being simultaneously prepared. To this end, the housing of the receiver unit has a clasp generally disposed on the back side of the housing opposite the display. The clasp grasps a belt, clothing, or the like, between the clasp and the housing. Alternately, the clasp may be rotated 180 degrees and used as a hook to suspend the receiver unit, as from a cabinet, a wall, or the like. The clasp is also removable and insertable in another aperture near the base of the receiver, with the clasp disposed at an oblique angle to the housing, such that the receiver unit will stand generally upright on a horizontal surface, such as a kitchen counter or a table.

It is a general object of the present invention to provide an improved wireless cooking thermometer and method for continuously monitoring the cooking progress of a food item while it is being cooked toward a selected doneness level.

Another object of this invention is to provide the user of the wireless cooking thermometer with an alert when the food item reaches the doneness level immediately below the selected doneness level, a different alert when the food item reaches the selected doneness level and yet a different alert if the food item continues to cook toward an overdone condition.

Another object of the present invention is to provide the user with a wide range of selectable food items, with a corresponding set of doneness levels for each selectable food item, and continuously displaying the cooking conditions in real time to provide ease and accuracy in cooking.

These and other objects, features and advantages of the invention will be clearly understood through a consideration of the following detailed description.

### BRIEF DESCRIPTION OF THE DRAWINGS

In the course of this description, reference will be made to the attached drawings, wherein:

FIG. 1 is a front elevational view of an embodiment of the transmitter unit of the wireless cooking thermometer of the present invention;

FIG. 2 is a side elevational view of the embodiment illustrated in FIG. 1;

FIG. 3 is a rear elevational view of the embodiment illustrated in FIG. 1;

FIG. 4 is the rear elevational view of FIG. 3 with a rear access door open;

FIG. 5 is an enlarged view of the display illustrated in the elevational view of FIG. 1 showing all operable segments of the display;

FIG. 6 is a front elevational view of an embodiment of the receiver unit of the wireless cooking thermometer of the present invention;

FIG. 7 is a side elevational view of the embodiment illustrated in FIG. 6;

FIG. 8 is an opposite side elevational view of the embodiment illustrated in FIG. 6;

FIG. 9 is a top plan view of the embodiment illustrated in FIG. 6;

FIG. 10 is a rear elevational view of the embodiment illustrated in FIG. 6, but with the attaching clasp disposed upwardly;

FIG. 11 is an opposite side elevational view, similar to FIG. 8, but with the mounting clasp inserted near the base of the receiver unit;

FIG. 12 is a cross-sectional view of the embodiment illustrated in FIG. 11 showing some of the interior construction and details;

FIG. 13 is an enlarged view of the display illustrated in the elevational view of FIG. 6 when the food item is in an overcooked condition;

FIG. 14 is an enlarged view of the display illustrated in the elevational view of FIG. 6 showing all operable segments of the display;

FIG. 15 is a block diagram of the circuitry utilized by the transmitter unit illustrated in FIGS. 1-4;

FIG. 16 is a block diagram of the circuitry utilized by the receiver unit illustrated in FIGS. 6-12;

FIG. 17 is a schematic diagram of the base band circuitry utilized by the transmitter unit illustrated in FIGS. 1-4;

FIG. 18 is a schematic diagram of the radio frequency (RF) circuitry utilized by the transmitter unit illustrated in FIGS. 1-4;

FIG. 19 is a schematic diagram of the base band circuitry utilized by the receiver unit illustrated in FIGS. 6-12; and

FIG. 20 is a schematic diagram of the RF circuitry utilized by the receiver unit illustrated in FIGS. 6-12.

### DESCRIPTION OF THE PREFERRED EMBODIMENTS

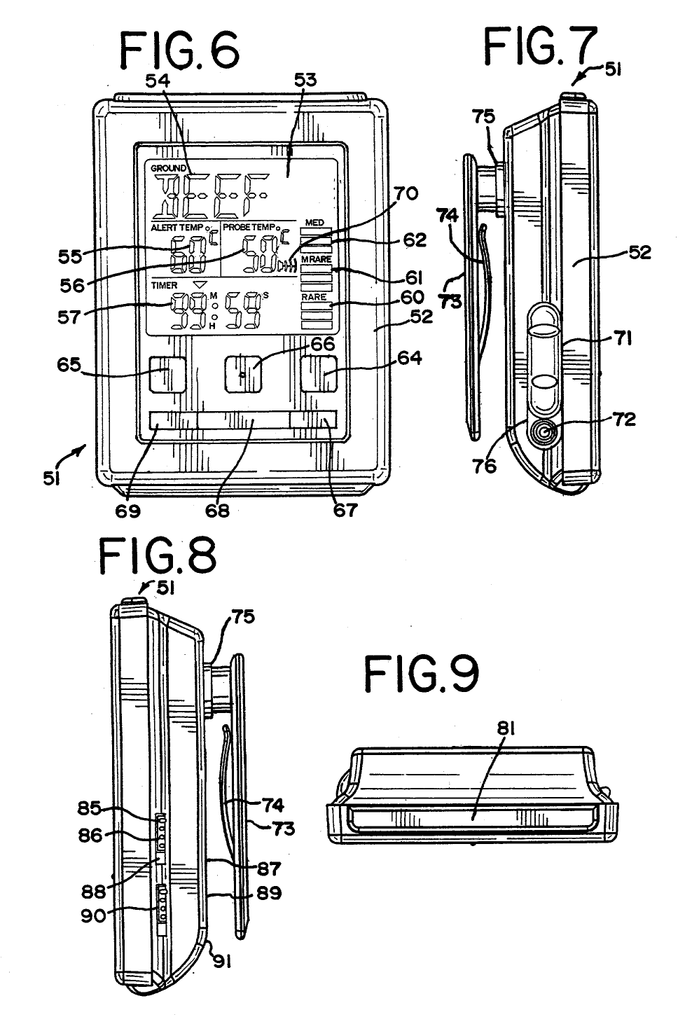

The illustrated embodiment of the wireless cooking thermometer consists of two portions including a transmitter unit, generally designated 21 in FIG. 1, and a receiver unit, generally designated 51 in FIG. 6.

The transmitter unit 21 in FIG. 1 includes a housing 22 made from a suitable material such as a thermoplastic or the like. The housing 22 has a display 23 with various indicia for displaying a plurality of conditions and events relating to cooking a food item (not shown). Display 23 is preferably of the liquid crystal display (LCD) type, and is further discussed below with reference to FIG. 5.

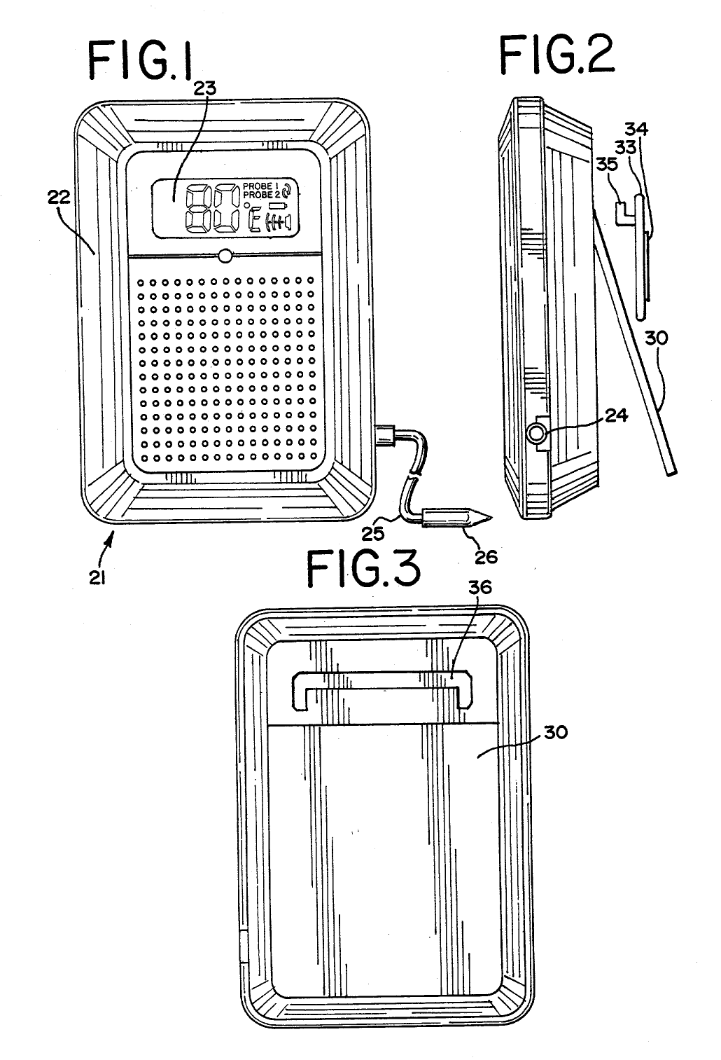

Transmitter unit 21 has an electrical connector 24 (FIG. 2) for receiving one end of a temperature probe 25. Temperature probe 25 is preferably of sufficient length to extend from the transmitter unit 21 to the food item being cooked. For example, temperature probe 25 may extend from the transmitter unit to the inside of a convection oven, to the inside of a microwave oven, to the inside a barbeque grille or into a pot or pan on top of a stove. The other end 26 of probe 25 contains a temperature sensing element such as a thermistor or the like. Probe end 26 is also generally sufficiently rigid and sharp to permit the end 26 to be inserted into a variety of food items, including many kinds of meat. Probe 25 provides an electronic signal representative of the internal temperature of the food item via a connector 24 to circuitry in the transmitter unit 21. This transmitter circuitry is presented in greater detail below.

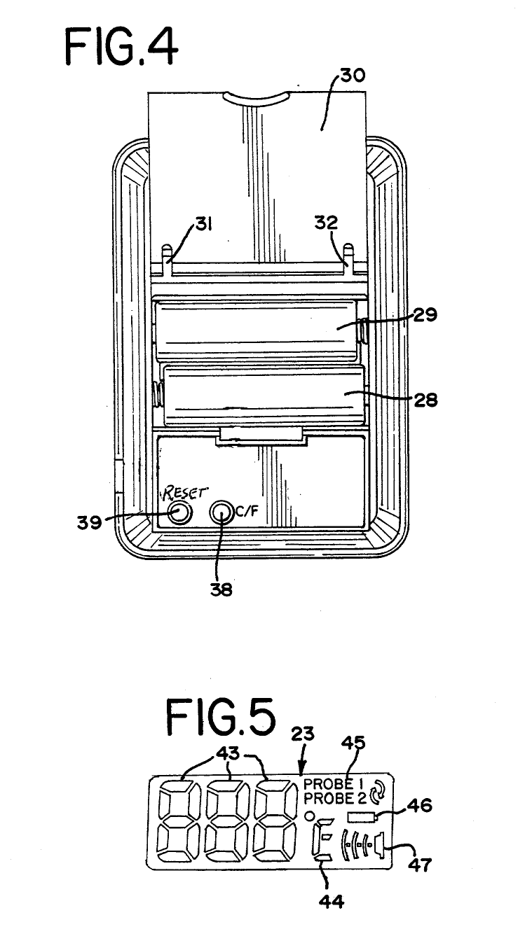

Transmitter unit 21 is not typically able to withstand the higher range of cooking temperatures encountered in ovens or grills due to the temperature limitations of some of its subcomponents, such as the LCD display 23 and a pair of internal batteries 28 and 29 (FIG. 4). In order to assist with placement of transmitter unit 21 near the food item being cooked, a rear door 30 (FIG. 2) may be partially opened to operate as a support for standing transmitter unit 21 on a generally horizontal surface, such as a counter or table. As seen in FIG. 4, door 30 has a pair of hinges 31 and 32 that may be configured to hold door 30 in the partially open position shown in FIG. 2.

Another means of locating transmitter unit 21 near the food item being cooked is by a clip 33 which has a protruding edge 35 suitable for insertion under a raised boss 36, as shown in FIGS. 2 and 3. One side of clip 33 may be provided with a securing means 34, such as double-sided tape or a magnet. Thus, clip 33 may secure transmitter unit 21 to many vertical surfaces, such as to a wall, to a cabinet or to the side of a stove.

Turning to FIG. 4, various internal components and controls become visible when the door 30 is fully opened. As previously mentioned, a pair of batteries 28 and 29 is disposed internally to provide operating power for the transmitter unit 21. Batteries 28 and 29 may be the common AA or AAA size. Also provided inside access door 30 are a plurality of switches and controls. A “C/F” switch 38 determines whether transmitter unit is measuring and displaying temperature in degrees Celsius or degrees Fahrenheit. A “RESET” switch 39 resets or initializes the transmitter unit 21.

All of the operable segments of the display 23 for the transmitter unit 21 are shown in FIG. 5. The current temperature of the food item is displayed by the three seven-segment numeric indicia 43. The alpha character 44 indicates whether the displayed temperature is in degrees Celsius “C” or in degrees Fahrenheit “F”. One of the two indicia 45 displays which of two temperature sensing probes, “PROBE 1” or “PROBE 2”, is selected for use. An indicator 46 is activated in response to detecting a low battery condition.

With reference to FIGS. 6-14, the structure and operation of the second portion of the wireless cooking thermometer, the receiver unit 51, will now be presented. Receiver unit 51 has a housing 52 that may be fabricated from any of a variety of materials including thermoplastic materials. Disposed within the housing 52 is a display 53. Display 53 may be any of the various types suited to this application, such as a display of the LCD type.

Display 53 has a plurality of indicia to provide the user with information about the cooking progress of the food item. In the preferred embodiment, the indicia at reference numeral 54 indicate one of a plurality of selectable meat types. The selectable meat types include “BEEF”, “VEAL”, “PORK”, “RIBS”, “LAMB”, “DUCK”, “TURKY” (for turkey), “CHICK” (for chicken), “HAM”, “GROUND BEEF”, “GROUND VEAL”, “GROUND PORK”, “GROUND LAMB”, GROUND TURKY” and “GROUND CHICK”. In the example illustrated in FIG. 6, “GROUND BEEF” has been selected by pressing a “MEAT” selection button 64.

The level of doneness is selected by a “TASTE” selection button 65. The selectable levels of doneness or taste are “RARE”, “M RARE” (for medium rare), “MED” (for medium) and “DONE” (for well done). In a bar graph, consisting of separate sections 60, 61 and 62 in the display 53, the uppermost displayed taste is “MED”. Thus, in the example illustrated in FIG. 6, the food item was previously selected to be cooked to the medium taste. Illumination of each of the three bar graph segments 60 and 61 indicates that the food item has already been cooked to, or past, the “RARE” and “M RARE” taste selections. Illumination of two of the three bar graph segments 62 indicates that the food item is reaching the selected doneness of “MED”. In accordance with one aspect of the invention, an alert indicator 70 is activated to alert the user that the cooking process is nearing completion and that the user should soon be ready to remove the food item from the cooking environment. Another alert indication by alert indicator 70 is again given when the food item reaches the selected doneness level. Yet another alert is given if the food item reaches a higher temperature than the selected doneness level, i.e., the food item is being overcooked. As an example, the pre-done alert may be two audible beeps, the done alert may be four audible beeps and the overdone alert may be continuous audible beeps, in addition to the operation of the alert indicator 70.

The “PROBE TEMP” indicia 56 is the current temperature of the food item as measured by the temperature probe 25 of transmitter unit 21 in FIG. 1. In the example of FIG. 6, the current temperature of the food item is displayed as 50 degrees C. A probe temp alert occurs if the probe temp indicia 56 are flashing. The probe temp alert signifies the occurrence of one of three abnormal probe circumstances. First, the probe temp has not increased by 2 degrees C. within the last five minutes. This indicates that the heat source may not be turned on or is too low, or that the meat is not centered in the center of the heat source. Second, two consecutive decreases in probe temp occurred prior to reaching the selected level of doneness. This indicates that the probe 25 may have fallen out of the food item. Third, the probe temp reads higher than the overcooked temperature. This situation indicates that the probe 25 may be through the food item and in contact with the heat source. Correction of this situation can prevent damage to the probe sensor 26.

Receiver unit 51 has an accessible switch to select either Celsius or Fahrenheit temperatures in a manner similar to that already discussed with respect to C/F switch 38 in transmitter unit 21. The “ALERT TEMP” 55 is a value that resides in the internal memory of receiver unit 51, and which corresponds to the doneness level selected by the “TASTE” selection button 65. Selection of a different doneness level than the “MED” level in the example of FIG. 6 will cause a different alert temperature value corresponding to the selected doneness level to be extracted from a look-up table in memory and displayed at the alert temperature indicia 55.

A “MEMORY” button 66 enables the user to customize the cooking levels or tastes to correspond to different values or temperatures than the values resident in memory. In this mode, the user may use button 65 (“+”) to increment the temperature or button 64 (“−”) to decrement the temperature for the selected cooking level.

For user convenience, display 53 is also provided with a “TIMER” 57. Timer 57 is capable of counting time in either an up mode or a down mode. The downwardly pointing arrow in FIG. 6 indicates that timer 57 is counting down in this example. Timer 57 displays the time in either minutes and seconds (M/S) or in hours and minutes (H/M). If operating in the up-counting mode, the user need only press the “START/STOP” button 68 to initiate the timer. In the down-counting mode, the user enters the starting time by pressing the “HR” (hour) button 65 or the “MIN” (minute) button 64 and pressing the “+” button 65. The “−” button 64 may also be used to adjust the starting time. The timer 57 may be reset or cleared by simultaneously pressing the “HR” and “MIN” buttons 65 and 67, respectively.

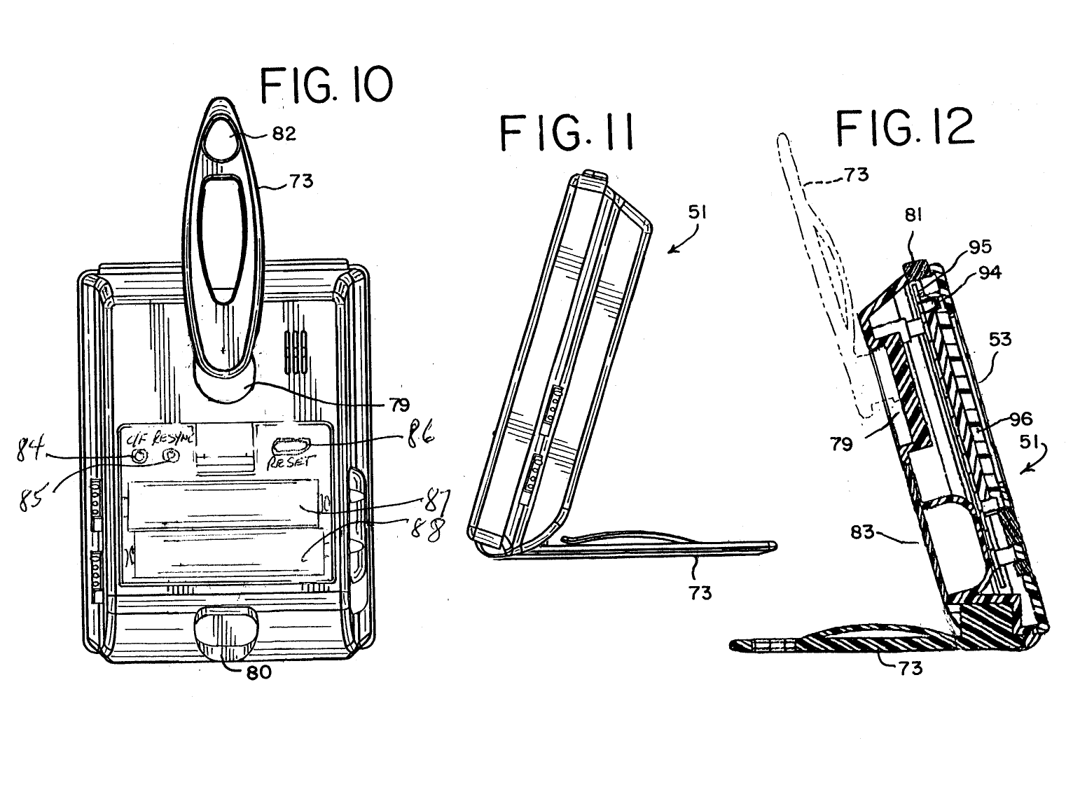

A side view of the receiver unit 51 is shown in FIG. 7. As can be seen from this view, receiver unit 51 is preferably provided with a clasp 73 with a resilient member 74 to grasp the user's clothing, such as a belt or the like, between clasp 73 and the back surface 76 of the receiver unit 51. Clasp 73 has an end 75 adapted to slide or snap into a recess or aperture 79 (FIG. 10). Clasp 73 may be inserted into the recess 79 in a downwardly pointing direction as illustrated in FIGS. 7 and 8 or in an upwardly pointing direction as illustrated in FIG. 10. As seen in FIG. 10, clasp 73 has an aperture 82 at its opposite end. Aperture 82 is useful for hanging receiver unit 51 from a fastener (not shown), such as from a cabinet or wall in general proximity to the cooking area. Clasp 73 may be alternately inserted into an aperture 80 shown in FIG. 10. As illustrated in FIG. 11, in this arrangement, clasp 73 acts as a base to support receiver unit 51 in a standing position, such as on a generally horizontal surface such as a counter or table. Receiver unit 51 is then disposed at an angle of about 20 degrees from an upright or vertical position.

Returning now to FIG. 7, located near the bottom of one side is a “DIRECT/RF” slide switch 71. Disposed immediately below switch 71 is an electrical connector 72 for receiving one end of a temperature probe, such as probe 25 in FIG. 1. Connector 72 enables the user to cook a food item without using the transmitter unit 21, i.e., receiver unit 51 directly receives information from a temperature probe at connector 72. Slide switch 71 determines the mode of use of the temperature probe. When switch 71 is in the position shown in FIG. 7, transmitter unit 51 is in the direct cooking mode with the temperature probe insertable into connector 72. Sliding switch 71 downwardly will cause switch 71 to cover connector 72. Thus, the temperature probe is only insertable into connector 24 of transmitter unit 21, and both units 21 and 51 of the wireless cooking thermometer are then in use. In this RF mode, transmitter unit 51 receives information from the temperature probe via transmitter unit 21. The RF mode of probe usage is generally the most convenient for the user because receiver unit 51 is then portable and may go wherever the user desires to go during the cooking process.

Disposed on an opposite side of receiver unit 51, as illustrated in FIG. 8, are a plurality of switches. A “POWER ON/OFF” switch 85 controls power from the batteries the electronic circuitry in receiver unit 51. A “HOLD” switch 86 is activated after the meat type and doneness selections are entered via buttons 64 and 65, as discussed above. That is, HOLD switch 86 locks in and prevents accidentally changing the selected meat or doneness entries, as might otherwise occur if buttons 64 or 65 are accidentally touched after the cooking process begins. HOLD switch 86 also locks all other entry buttons from changing any user entries due to accidental touching, except the ALERT STOP/LIGHT button 81. A “KEY TONE” switch 88 enables or disables an audible alert tone as previously described. A “BAR SEGMENT” switch 89 enables or disables the bar segments 60, 61 and 62 in the bar graph in display 53 (FIG. 6). A “USER TEMPERATURE PREFERENCE” switch 90 enables or disables the ability of the user to program his/her temperature preferences into memory instead of using the preprogrammed temperature values. A “RE-SYNC” switch 91 is used to resynchronize the RF signaling operation between the transmitter unit 21 and the receiver unit 51 if the signal is lost. Loss of the signal may typically occur if the user carries the receiver unit out of range of the transmitter unit during the cooking process.

FIG. 9 is the top surface of the receiver unit 51. It is the surface that the user would most readily see if the receiver unit 51 is attached near the user's waist, as to the user's belt or pants pocket. This top surface is provided with an “ALERT STOP/LIGHT” button 81 to stop or terminate the various alert functions. If button 81 is fabricated from a clear or translucent plastic, button 81 may flash upon initiation of one of the previously described alert functions. Alternately, as will be hereinafter described, button 81 may be lit in one color, such as green, while the food item is being cooked toward the desired degree of doneness. When the desired degree of doneness is achieved and if the food item is permitted to continue to cook past the selected degree of doneness, button 81 may turn to a second color, such as red. Such color changes provide the user with a quick indication of the status of the cooking process.

FIG. 10 illustrates the back side of receiver unit 51 with the access door removed. Portions of FIG. 10 have previously been discussed with reference to the multiple uses and multiple positions of the clasp 73. Disposed behind the access door are three switches 84, 85 and 86. A “C/F” switch 84 sets the receiver unit 51 for operation in either the Celsius mode or the Fahrenheit mode. A “RESYNC” switch 85 resynchronizes the receiver unit 51 to the transmitter unit 21 when the RF signal is lost. A “RESET” switch 86 initializes or resets the previously selected entries such as the meat selection and the taste selection. A pair of batteries 87 and 88 supply operating power to the receiver unit 51.

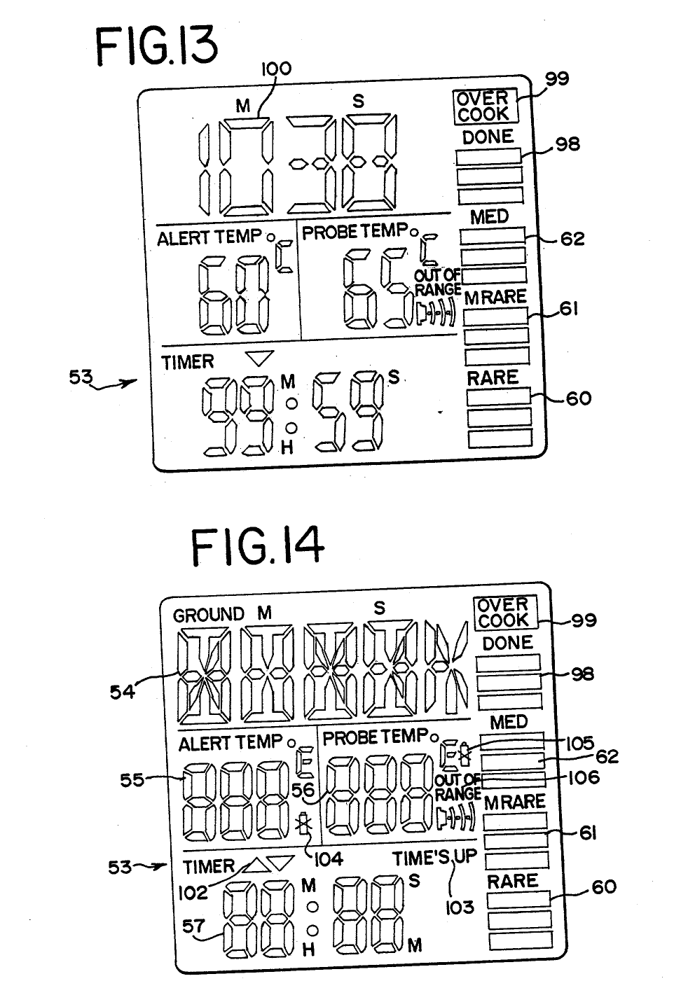

FIG. 12, which is a cross-sectional view of FIG. 11, illustrates some of the internal construction of the receiver unit 51. A printed circuit board (PCB) 95 is disposed in the interior of the receiver unit 51. PCB 95 has electronic circuitry for enabling and performing the various wireless thermometer cooking functions. One or more light emitting diodes (LEDs) 94 are disposed on PCB 95 to provide back lighting for the LCD display 53 and the button 81. Preferably, receiver unit 51 is provided with LEDs of two different colors such that display 53 and button 81 may be lit one color under certain operating conditions, and another color under other operating conditions. One or more layers of a light dispersing medium 96 may be situated between PCB 95 and display 53 to more uniformly provide the back lighting to display 53.

With reference to FIG. 6, the features of display 53 were previously discussed for the situation where the food item was being cooked to a selected MED level of doneness, and the cooking process had not yet reached that selected level of doneness. FIG. 13 illustrates information typically displayed on display 53 for the situation where the food item has been cooked beyond the selected level of doneness. The bar graph, previously consisting of segments 60, 61 and 62, now consists of additional segments 98 up to the DONE taste. In addition, an OVER COOK indicia 99 is also now activated or illuminated. The previously selected food item, GROUND BEEF at indicia 54 in FIG. 6 has now been replaced by a count up timer 100 to indicate the amount of time that the food item has been cooked past the selected degree of doneness. The amount of time in the overcooked condition will give the user a sense of how much the food item is overcooked. Timer 100 displays the elapsed time in minutes and seconds (M/S).

FIG. 14 illustrates all of the operable segments of display 53 for the receiver unit 51. Most of the selectable meat choices consist of four alpha characters, such the BEEF example illustrated by indicia 54 in FIG. 6. However, the food item indicia 54 consist of five alpha characters to display CHICK for chicken and TURKY for turkey. The four leftmost characters are also suited to display numerals when operating as the count up timer 100 in FIG. 13. Timer 57 has separately operable up and down arrows 102 to indicate whether timer 57 is counting up or down. Timer 57 is also equipped with a “TIME'S UP” indicator 103 to alert the user that time has expired when timer 57 is operating in the down-counting mode and the time reaches zero. Display 53 has low battery indicators 104 and 105 to alert the user that the batteries in receiver unit 51 need replacement. An “OUT OF RANGE” indicator 106 lets the user know that the receiver unit 51 is not receiving a signal from the transmitter unit 21. When receiver unit 51 is attached to the user's clothing, an OUT OF RANGE indication usually means that the user has moved too far away from transmitter unit 21 to receive a signal from the transmitter.

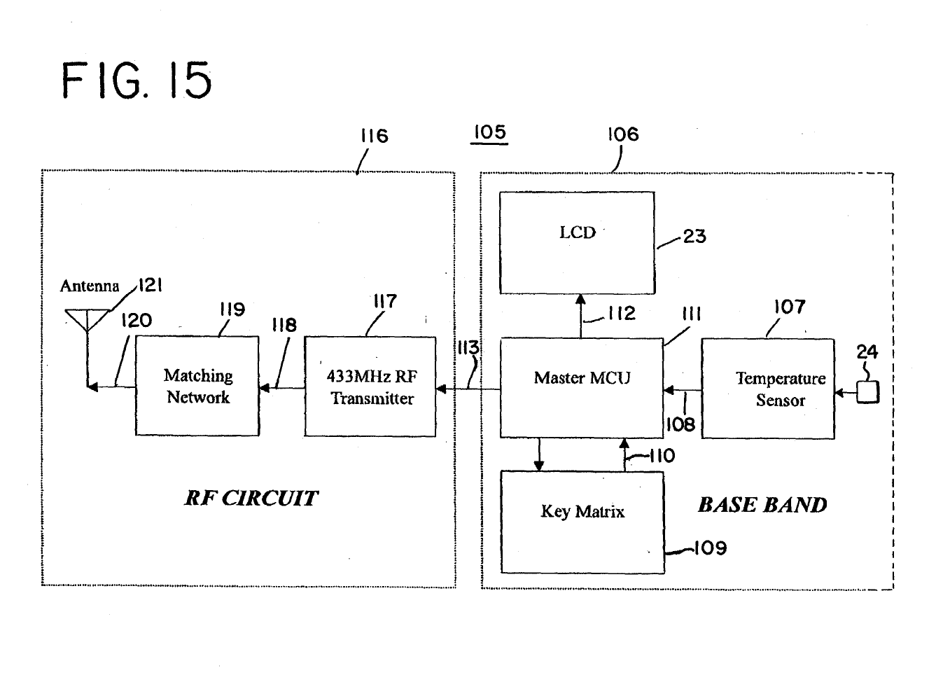

A block diagram of the circuitry, generally designated 105, of the transmitter unit 21 is shown in FIG. 15. Transmitter circuitry 105 consists of a base band portion 106 and an RF portion 116. As previously discussed, a connector 24 on the external housing of transmitter unit 21 receives one end of a temperature probe 25. The signal from probe 25 is presented as an input to temperature sensor circuitry 107. The circuitry 107 conditions the temperature signal and utilizes an analog to digital converter to translate the analog temperature signal to a digital form. This digital form of the temperature signal is sent via one or more lines 108 to a microcontroller unit (MCU) 111. MCU 111 constantly monitors the temperature signal to determine the current temperature of the food item. A key matrix 109 consists of the various switches 38 through 42 (FIG. 4) that determines the operational characteristics of transmitter unit 21. Key matrix 109 inputs the status of the various switches on one or more lines 110 to MCU 111. MCU 111 uses the inputs from key matrix 109 to determine the desired operating mode. MCU 111 provides information for display on LCD 23 via one or more lines 112. Typical information for display by LCD 23 includes the current food temperature, the Celsius or Fahrenheit mode and the probe 1 or probe 2 mode, as previously discussed in connection with FIG. 5. MCU 111 also provides a temperature signal in digital form to the RF portion 116 on line 113. Rather than having a continuous digital signal on line 113, MCU 111 preferably provides the digital signal for a brief time at spaced intervals The spaced intervals are generally in the range of 10 to 30 seconds, and preferably about every 10 seconds. Since the temperature of the food item is slowly rising as it cooks, there is no need for a continuous signal. Furthermore, the brief signal at spaced intervals reduces the power drain on the batteries, thereby increasing the life of the batteries. Thus, portions of the transmitter circuitry 105 may be inoperative or may be in a sleep mode during portions of the spaced intervals.

The transmitter portion 116 has an RF transmitter 117 to modulate the digital temperature signal on line 113 up to an RF signal for transmission on line 118. In the example shown in FIG. 15, the RF signal is 433 MHz. Transmitter 117 may employ On/Off Keying (OOK), a form of amplitude modulation, which is well known in the arts. A matching network 119 further conditions the RF temperature signal on line 118, and provides the RF signal to an antenna 121 for transmission of the RF signal to the receiver unit 51.

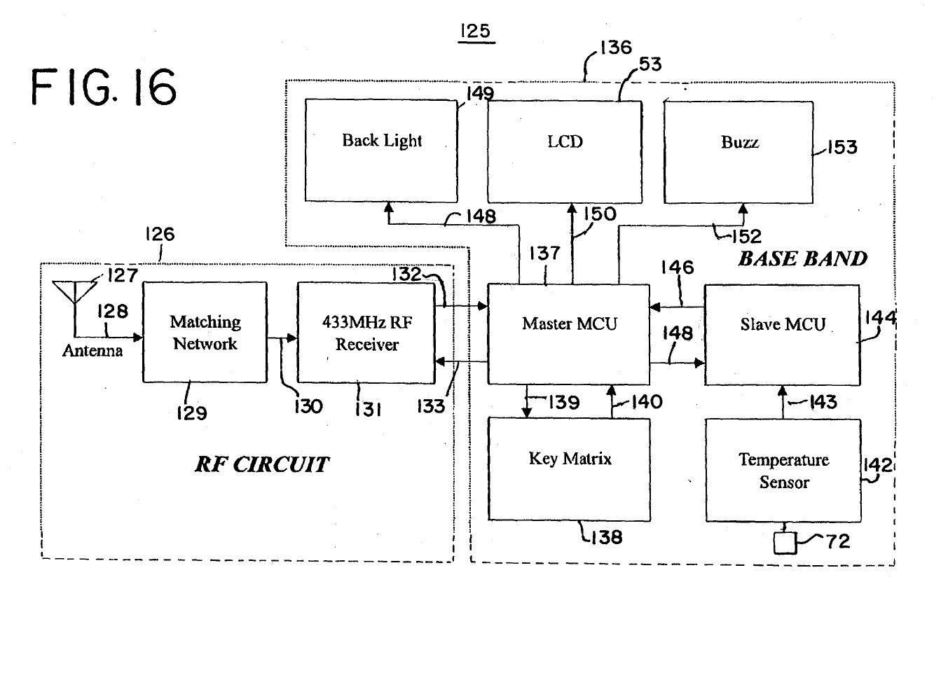

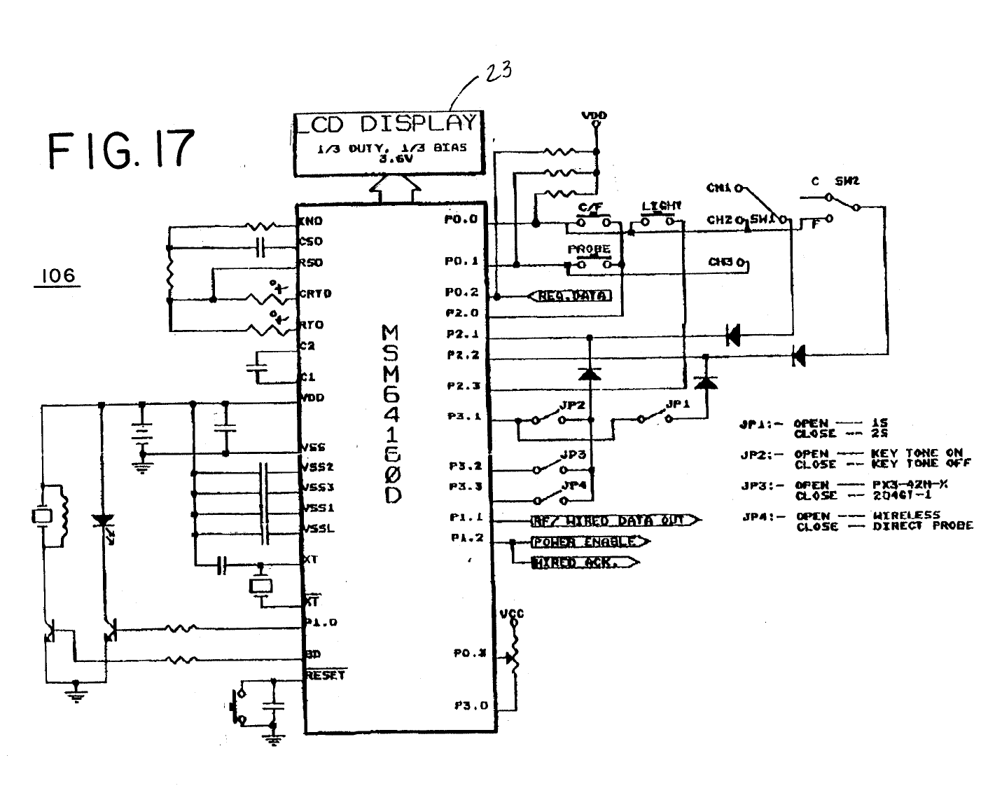

Turning to FIG. 16, the receiver unit 51 has circuitry, generally designated 125, including an RF portion 126 and a base band portion 136. RF portion 126 has an antenna 127 for receiving the transmitted RF signal from transmitter unit 21. The received RF signal is passed by line 128 to a matching network 129, which filters the RF signal before passing it on to an RF receiver 131 via line 130. RF receiver 131 may be of the superheterodyne type. RF receiver 131 demodulates the 433 MHz signal to recover the digital temperature signal. Line 132 presents the recovered digital temperature signal to a master MCU 137 in the base band portion 136 of the receiver circuitry 125.

The operating mode of the master MCU 137 is determined by the user's inputs in a key matrix 138. Matrix 138 consists of the plurality of buttons and switches 64 through 69, 71, 85 through 91 (FIGS. 6-8) and the reset and C/F buttons behind the battery door 83 in FIG. 10. Activation of the various buttons and switches is conveyed by one or more lines 140 to master MCU 137.

As previously described with regard to FIG. 7, receiver unit 51 has a connector 72 for receiving one end of a temperature probe 25 for cooking in the direct mode. In FIG. 16, connector 72 is electrically connected to a temperature sensor 142. Temperature sensor 142 is similar in structure and function to the corresponding temperature sensor 107 in FIG. 15 to provide a temperature signal on a line 143 to a slave MCU 144. Slave MCU 144 converts the temperature signal on line 143 to a digital signal compatible with the inputs of master MCU 137. Slave MCU 144 bidirectionally communicates with master MCU 137 by means lines 145 and 146.

Master MCU 137 provides information on one or more lines 150 to be displayed on the LCD display 53. Such information is displayed by the various indicia on display 53 as previously discussed with reference to FIGS. 6, 13 and 14. Said information includes the current food item temperature whether received indirectly from transmitter unit 21 or directly at connector 72 on the receiver unit housing 52. Master MCU 137 also controls the back lighting 149 for the LCD display 53 on one or more lines 148. Back lighting 149 is provided by one or more LEDs 94 as previously discussed with reference to FIG. 12. Master MCU 137 further controls a buzzer 153 on a line 152. Buzzer 153 may take various forms including a speaker to provide audible alerts, including distinct tones or sequences of tones representative of different cooking conditions.

Master MCU 137 also controls the RF portion 126 by actuating line 133 to enable the RF circuitry. As will be recalled from the discussion of the transmitter circuitry in FIG. 15, transmitter unit 21 preferably transmits its RF signal only briefly at spaced intervals, such as at every 10 seconds. In similar fashion, battery life in receiver unit 51 can be conserved if portions of the receiver circuitry 125 are active only when required. Thus, master MCU 137 preferably uses line 133 to briefly enable the RF circuitry 126 only during that portion of the spaced intervals when a transmission from transmitter unit 21 is expected. To this end, MCU 137 monitors reception of signals from transmitter unit 21 to ensure that receiver unit 51 is synchronized with transmitter unit 21. If MCU 137 fails to receive a signal from transmitter unit during three successive spaced apart intervals, MCU 137 will assume that it is out of range for receiving signals and will cause the OUT OF RANGE indicia 106 (FIG. 14) to be illuminated. MCU 137 will thereafter continuously search for a signal from transmitter unit 21. Upon finding a signal, MCU 137 will cause the timing of the receiver unit 51 to become resynchronized with the brief time window in which transmitter unit 21 is transmitting its RF signal.

If temperature probe 25 is connected to connector 72 of the receiver unit 51 in the direct cooking mode, MCU 137 may use line 133 to continuously disable the RF circuitry portion 126 since no signal will be received from transmitter unit 21 in the direct cooking mode. This will assist in conserving power in the receiver unit 51 and extend the life of the batteries.

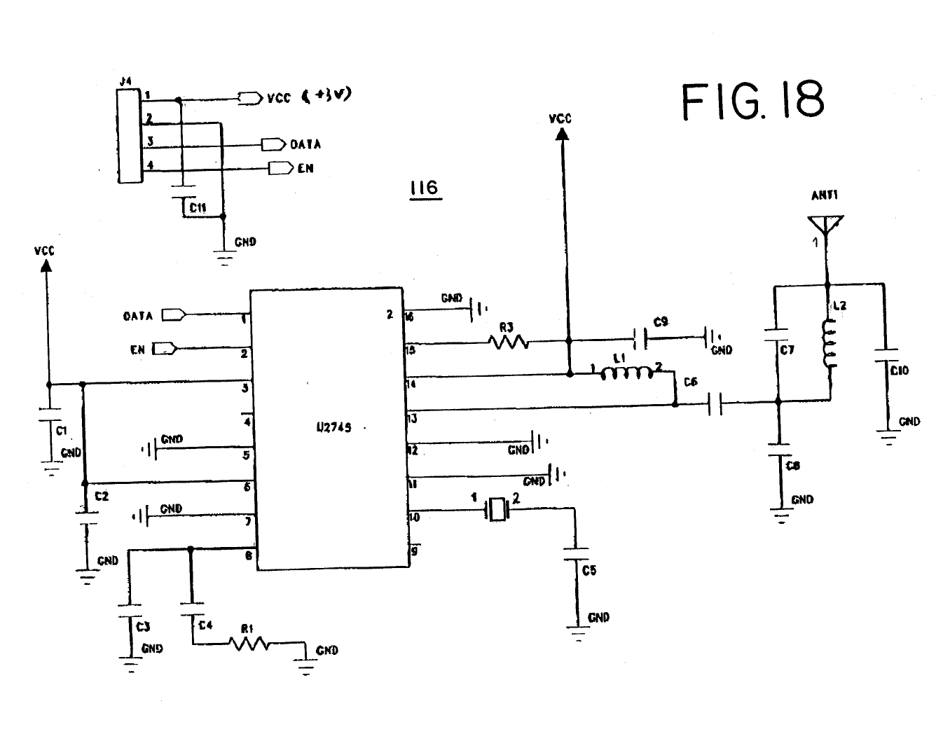

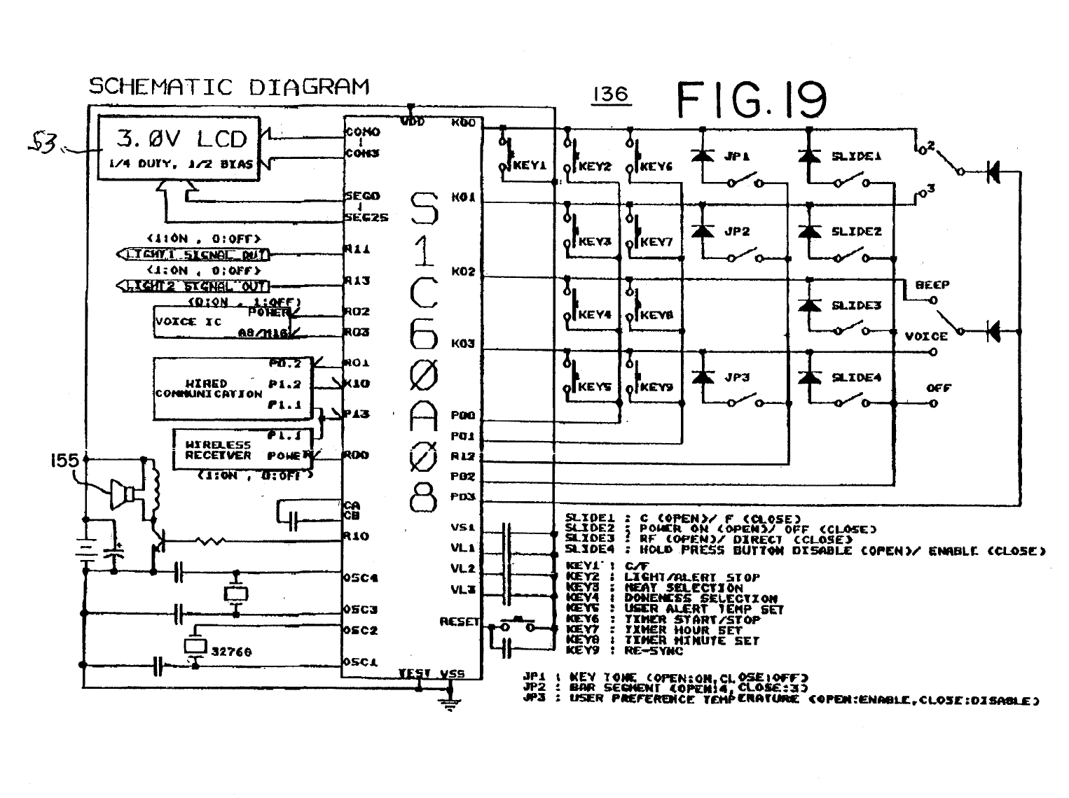

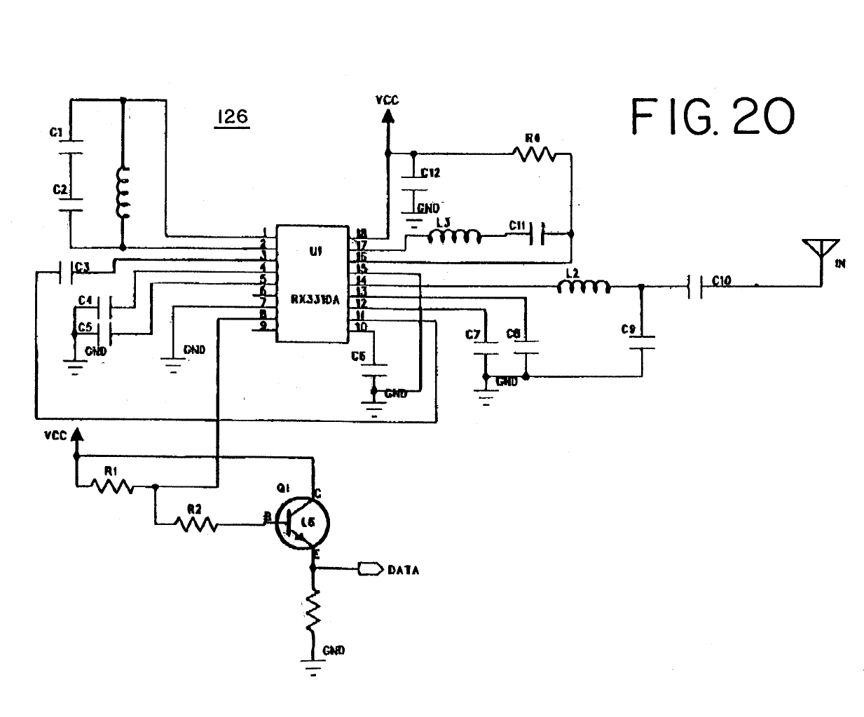

A schematic diagram of the base band circuitry 106 used by the transmitter unit 21 is illustrated in FIG. 17, and a schematic diagram of the RF circuitry 116 for the transmitter unit 21 is set forth in FIG. 18. Similarly, FIG. 19 is a schematic diagram of the base band circuitry 136 used in the receiver unit 51, and FIG. 20 is a schematic diagram of the RF circuitry 126 used in the receiver unit 51. In FIG. 19, a speaker 155 corresponds to the buzzer 153 in the block diagram of FIG. 16.

The structure and operation of the various portions of the wireless cooking thermometer, including the transmitter unit 21 and the receiver unit 51 have been discussed in detail. We will turn now to a representative cooking process for a better understanding of the overall operation of the wireless cooking thermometer.

The first step is to turn on the receiver unit 51 by moving the POWER switch 85 (FIG. 8) to the ON position.

Next, the type of food item to be cooked needs to be selected. As previously mentioned, there are 15 different types of meat to select from, including BEEF, PORK, CHICKEN, TURKEY, VEAL, LAMB, HAM, DUCK, RIBS, GROUND BEEF, GROUND PORK, GROUND CHICKEN, GROUND TURKEY, GROUND VEAL and GROUND LAMB. The user selects the appropriate meat choice by pressing the MEAT button 64 (FIG. 6). Receiver unit 51 will sequentially step through the available meat choices until the desired meat type is displayed by the indicia 54 on display 53.

The desired level of doneness is then selected by pressing the TASTE button 65 (FIG. 6). Receiver unit 51 sequentially steps through the four levels of doneness, including RARE, MEDIUM RARE (sometimes abbreviated as M RARE), MEDIUM (sometimes abbreviated as MED) and DONE, until the desired taste is displayed by display 53. It should be noted the lower levels of doneness will also be displayed. That is, if the MED level of doneness is selected as illustrated in the example in FIG. 6, the lower levels of RARE and M RARE will also appear on the display 53 since the cooking process must go through the RARE and M RARE levels to get to the MED level. However, a higher level, such as DONE, will not appear if the MED level is selected. Thus, the highest level of doneness appearing on display 53 is the selected level of doneness. Each level of doneness corresponds to a preselected temperature which is displayed as the PROBE TEMP at indicia 56 in FIG. 6.

It should be noted that not all levels of doneness are available for all meat types. Due to potential bacteria and other health considerations, it is usually desirable to cook certain meat types to a minimum DONE level, i.e., above the RARE, M RARE and MED levels. Accordingly, the following taste choices are initially preprogrammed into the receiver unit 51 of the wireless cooking thermometer:

TABLE

| | Beef/Lamb/ | | Turkey/Chicken/ | Ground Beef/Pork/ | Ground Turkey/ |
|---|---|---|---|---|---|
| Doneness | Veal/Ribs | Pork | Duck | Lamb/Veal/Ham | Chicken |
| Well Done | 170° F./76.6° C. | 170° F./76.6° C. | 180° F./82.2°C. | 160° F./71.1° C. | 165° F./73.9° C. |
| | & Above | & Above | & Above | & Above | & Above |
| Medium | 160° F./71.1° C. | N/A | N/A | N/A | N/A |
| Medium Rare | 145° F./62.8° C. | N/A | N/A | N/A | N/A |
| Rare | 140° F./60° C. | N/A | N/A | N/A | N/A |

Alternatively, the user may customize any of the doneness selections by pressing the MEMORY button 66 after the desired MEAT and TASTE preferences have been entered. The ALERT TEMP display 55 will begin flashing to indicate that receiver unit 51 is now in the mode to modify the default temperature values resident in the memory of receiver unit 51 for any of the meat choices and doneness levels listed in the table above. The user then presses either the TASTE or MEAT button 65 or 64, respectively, which are now useable as “+” or “−” buttons, respectively, to either increment or decrement the default temperature value that corresponds to the selected doneness level. Again pressing MEMORY button 66 will complete modification of the temperature for the selected doneness level. Such modifications remain in the memory of receiver unit 21 and may be recalled in future cooking events by pressing the MEMORY button after entering the MEAT and TASTE preferences.

After selecting either the default doneness level or the modified doneness level, the selected preferences for both the MEAT and the TASTE are saved for the duration of the cooking process by moving the HOLD switch 86 to the HOLD position. Thereafter, any accidental touching of the MEAT and/or TASTE buttons 64 or 65, respectively, will not result in any change of the entered selections.

The transmitter unit is turned ON by pressing the C/F button 38 in FIG. 4. Of course, the C/F button also sets the temperature measurement in either Celsius or Fahrenheit degrees.

Temperature probe 25 is then connected to transmitter unit 21 at connector 24. The other end of probe 25 is inserted into the meat. As the meat is cooking, the current temperature of the meat can be observed at any time on display 53 of receiver unit 51 at either the numerical indicia 56 in the PROBE TEMP field or by reference to the bar graphs 60, 61 and 62 interspersed between the doneness levels.

The circuitry within receiver unit 51 constantly monitors and compares the meat temperature, as displayed in the PROBE TEMP field, against the preprogrammed temperatures for the various levels of doneness, including any user-modified doneness temperatures. When the meat reaches the temperature of the doneness level immediately below the previously selected level of doneness, receiver unit 51 will issue one or more pre-done alerts. This is to forewarn the user that the meat is nearing the desired level of doneness, and that the user will soon need to be ready to remove the meat from the cooking environment upon reaching the selected level of doneness. This pre-done alert may be in different forms or formats. In the preferred embodiment of this invention, receiver unit 51 emits one or more audible sounds, such as a tone in the form: Beep, Beep. Receiver unit 51 also flashes the backlighting of LCD display 53 by controlling the illumination provided by LEDs 94. As previously discussed, at this point in the cooking process, the backlighting supplied by LEDs 94 may be a green color. However, other colors may also be used. Receiver unit 51 also causes the meat indicia 54 to flash. For example, with the selection of BEEF in FIG. 6, indicia 54 will begin to alternately display “CHECK”, “BEEF”, “CHECK”, “BEEF”, etc. All of these pre-done alerts may be stopped or cancelled by pressing the ALERT STOP/LIGHT button 81. There are some instances when the selected level of doneness does not have a lower level, such as for those meats with only one level of doneness, e.g., PORK. Another instance is where the user selects RARE, the lowest level of doneness. In these situations, the temperature for the pre-done alert is 5 degrees Fahrenheit below the selected level of doneness.

Receiver unit 51 issues one or more done alerts when the meat reaches the selected level of doneness. The done alerts may also be in different forms or formats. Receiver unit again emits one or more audible sounds, such as a tone in the form: Beep, Beep, Beep, Beep. This audible done alert preferably uses a different number of Beeps, a different frequency of tones or a different sequence of tones so that the user can discriminate the pre-done alert from the done alert. Receiver unit 51 again causes the backlighting of LCD display 53 to flash. The rate of flashing for the done alert may be different than the rate of flashing for the pre-done alert so that the user can discriminate between these alerts. The color of the backlighting may be the same as for the pre-done condition. The meat indicia 54 will alternately display “BEEF”, “DONE”, “BEEF”, “DONE”, etc. As with the pre-done alerts, these done alerts may be stopped or cancelled by pressing the ALERT STOP/LIGHT button 81.

If the meat is permitted to cook beyond the selected level of-doneness to the next level of doneness, the receiver unit 51 issues a new set of alerts to the user. Instead of emitting one or more audible sounds in the form of sets of two or four Beeps, as for the pre-done and done levels respectively, receiver unit 51 may now emit continuous Beeps. As stated above, the audible alert may alternately be a different frequency of tones, or a different sequence of tones so that the overdone condition has a different sound as compared to the pre-done and done levels. Receiver unit 51 causes the backlighting of the LCD display 53 to begin flashing, such as a different color, preferably red. Alternately, the backlighting could flash at a different rate than the pre-done or done levels. At this time, the meat indicia 54 will change to a count-up timer 100 in FIG. 13, to count the time elapsed since reaching the overdone level. The OVER COOK indicator 99 will also illuminate. The user may stop or terminate the overdone alerts by pressing the ALERT STOP/LIGHT button 81.

Receiver unit 51 causes similar visual and audible alerts to occur upon occurrence of the probe alert or the out of range signaling conditions described above. Again, these alerts can be stopped by pressing the ALERT STOP/LIGHT button 81.

After completing the cooking of the food item, the user may press the MEAT button 64 to begin programming the receiver unit 51 for cooking of another meat type. If the user fails to turn the POWER ON/OFF switch 85 to the OFF position after completing cooking, receiver unit 51 will go into a sleep mode after about 80 minutes of nonuse to conserve battery life. Pressing the MEMORY button 66 will recall all of the prior settings.

Operation of the direct probe cooking with receiver unit 51 will now be reviewed. In the direct mode, receiver unit 51 directly receives temperature information from a temperature probe instead of receiving an RF signal from transmitter unit 21. As before, after turning the POWER switch 85 to the ON position, the user selects the food item by pressing the MEAT button 64, the desired doneness by pressing the TASTE button 65, or selects another doneness preference by pressing the MEMORY button 66. The user now moves the DIRECT/RF switch 87 to the DIRECT position and connects the temperature probe 25 to connector 72 on the side of the receiver housing (FIG. 7). Receiver unit 51 now directly receives a temperature signal at the temperature sensor circuitry 107 in FIG. 15. The remaining cooking steps, including the various alert functions, will operate as previously presented for the wireless cooking when using transmitter unit 21 in the indirect or RF mode.

Operation of timer 57 will now be briefly considered. To operate timer 57 as a count-up timer, the START/STOP button 68 is pressed. Timer 57 begins to immediately start counting up. Pressing the START/STOP button 68 again will stop the timer. Pressing both the HR and MIN buttons 69 and 67, respectively, will reset the timer to zero.

To use the timer 57 in the count-down mode, the user presses the HR and MIN buttons 69 and 67, respectively, to set the time from which timer 57 will start. Pressing the START/STOP button 68 will initiate the countdown from the preselected time. The countdown may be stopped at any time by pressing the ALERT STOP/LIGHT switch 81. If the countdown reaches zero, the TIME'S UP indicator 103 in FIG. 14 will illuminate. Pressing of the START/STOP button 68 will restore the previously countdown setting. Simultaneously pressing the HR and MIN buttons 69 and 67, respectively, will reset the timer to zero.

It will be understood that the embodiments of the present invention which have been described are illustrative of some of the applications of the principles of the present invention. Numerous modifications may be made by those skilled in the art without departing from the true spirit and scope of the invention.

1. A wireless cooking thermometer comprising:
a transmitter unit having a temperature sensor for insertion into a food item to sense the current temperature of the food item as said food item is being cooked,
said transmitter unit having a housing for containing transmitter circuitry,
said temperature sensor supplying a temperature signal representative of the temperature of the food item to the transmitter circuitry,
said transmitter circuitry translating said temperature signal into a radio frequency (RF) signal, and transmitting the RF signal,
a receiver unit having a housing for containing receiver circuitry for receiving said transmitted RF signal and for converting said RF signal into a signal with information about the current temperature of the food item,
user selectable inputs to select one of a plurality of food types and one of a plurality of doneness levels for the selected food type,
a display disposed on said receiver housing having a plurality of indicia for displaying the selected food type and the selected doneness level, and
a memory for storing a plurality of values representative of a plurality of doneness levels for each of a plurality of different types of food items,
whereby said transmitter circuitry compares the current food temperature from said converted RF signal to the selected doneness level for the selected food type and provides an indication when the temperature of the food item reaches the selected doneness level.

2. The wireless cooking thermometer in accordance with claim 1, wherein said display on the receiving unit also displays the current temperature of the food item being cooked.

3. The wireless cooking thermometer in accordance with claim 2, wherein said display in the receiving unit has a visual indicator subdivided into a plurality of portions, each of the plurality of visual indicator portions corresponding to one of a plurality of doneness levels, whereby said transmitter circuitry determines the current doneness level by comparing the current food temperature to the values for the plurality of doneness levels stored in memory and illuminates that portion of the visual indicator which corresponds to the current doneness level to indicate the progress of the cooking of the food item.

4. The wireless cooking thermometer in accordance with claim 1, wherein the transmitter unit periodically transmits its RF signal to the receiver.

5. The wireless cooking thermometer in accordance with claim 1 wherein said display on said receiver unit has an out of range indicator, said receiver circuitry being responsive to the absence of a predetermined number of successive RF signal transmissions from the transmitter to activate the out of range indicator to indicate that the receiver unit is not receiving current temperature information from the transmitter unit.

6. The wireless cooking thermometer in accordance with clam 5 wherein said receiver circuitry deactivates the out of range indicator when the receiver unit begins to again receive the RF signal from the transmitter un it.

7. The wireless cooking thermometer in accordance with claim 1 wherein said display on said receiver unit includes an overcook indicator, said receiver circuitry being responsive to activating said overcook indicator a predetermined time after said receiver circuitry determines that the temperature of the food item has reached the selected level of doneness.

8. The wireless cooking thermometer in accordance with claim 7 whereupon determining that said food item is being overcooked, said indicia for displaying the selected food item on the display changes to display the amount of time that the food item has been overcooked.

9. The wireless cooking thermometer in accordance with claim 1 wherein said receiver unit contains an annunciator capable of providing an audible sound or tone, said receiver circuitry responsive to a determination that the food item has reached a doneness level one level below the selected level to actuate the annunciator to provide a first distinct sound or tone, the receiver circuitry responsive to the food item reaching the selected doneness level to actuate the annunciator to provide a second distinct sound or tone, and the receiver circuitry responsive to a predetermined temperature after the food item has reached the selected doneness level to provide a third distinct sound or tone indicative of the onset of an overcooked food condition.

10. The wireless cooking thermometer in accordance with claim 9 wherein said first, second and third distinct sounds or tones comprise a sequence or pattern of tones.

11. The wireless cooking thermometer in accordance with claim 1 wherein the display on said receiver unit is of the liquid crystal display (LCD) type, said receiver unit contains light emitting diodes (LEDs) disposed in the receiver unit housing to provide backlighting for the LCD, some of said LEDs having a light output of a first color and others of said LEDs having a light output of a second color, said receiver circuitry causing the LEDs of the first color output to be illuminated until the food item reaches the selected level of doneness, said receiver circuitry causing the LEDs of the second color output to be illuminated a predetermined temperature after the food item reaches the selected level of doneness to indicate that the food item is being subjected to overcooking.

12. The wireless cooking thermometer in accordance with claim 1 wherein the housing of the receiver unit has an aperture for receiving one end of a clasp, with the clasp disposed in a generally downward direction when inserted into said aperture, said clasp adapted to grasp the user's clothing between the clasp and the receiver unit.

13. The wireless cooking thermometer in accordance with claim 1 wherein the housing of the receiver unit has an aperture for receiving a clasp, with the clasp disposed in a generally upward direction when inserted into said aperture, said clasp having an aperture at its opposite end for hanging the receiver unit.

14. The wireless cooking thermometer in accordance with claim 1 wherein the housing of the receiver unit has an aperture near the base of the housing unit for receiving a clasp, the clasp being disposed at a generally oblique angle to the housing of the receiver unit when inserted into said aperture such that said receiver unit and clasp will stand on a generally horizontal surface.

15. The wireless cooking thermometer in accordance with claim 1 wherein said memory is programmed to contain a plurality of meat types as the food item and said memory is programmed to contain a plurality of values representing different doneness levels for each of said meat types.

16. The wireless cooking thermometer in accordance with claim 15 wherein said receiver unit is provided with at least one user input for selecting one of the plurality of meat types and one of the plurality of doneness levels.

17. The wireless cooking thermometer in accordance with claim 16 wherein said display has indicia for displaying the selected meat type.

18. The wireless cooking thermometer in accordance with claim 17 wherein when said receiver circuitry determines that the temperature of the selected meat reaches the selected doneness level, the receiver circuitry causes the selected meat indicator to alternately flash the name of the selected meat and a done status to alert that the cooking process is done.

19. The wireless cooking thermometer in accordance with claim 18 wherein when said receiver circuitry determines that the temperature of the selected meat reaches one level below the selected doneness level, the receiver circuitry causes the selected meat indicator to alternately flash the name of the selected meat and a pre-done status to alert that the cooking process is nearing conclusion.

20. The wireless cooking thermometer in accordance with claim 1 wherein a user may use the user selectable inputs to modify one of the preprogrammed doneness levels for any selected type of food.

21. A process for cooking a food item with a wireless cooking thermometer including a transmitter unit with a temperature probe for sensing the temperature of the food item and transmitting a temperature signal to a receiving unit, said receiver unit having circuitry for receiving the transmitted temperature signal, said receiver circuitry further including a memory with values representative of a plurality of doneness levels for the food item preprogrammed into the memory and said receiver circuitry including means of generating alerts, comprising the steps of:
recovering the current food temperature from the received temperature signal in the receiver unit,
comparing the current food temperature to the representative values of the various doneness levels preprogrammed into the memory,
providing a first alert when the temperature of the food item reaches one doneness level below the selected doneness level, and
providing a second alert, distinctive from the first alert, when the temperature of the food item reaches the selected doneness level.

22. The process for cooking a food item with a wireless cooking thermometer in accordance with claim 21 comprising the additional step of:
providing a third alert, distinctive from the first and second alerts, when the temperature of the food item reaches one doneness level above the selected doneness level.
